(19) United States
(12) Patent Application Publication
(10) Pub. No.: US 2017/0288306 A1
(43) Pub. Date: Oct. 5, 2017

(54) ADJUSTABLE PHASE SHIFTING DEVICE FOR ARRAY ANTENNA AND ANTENNA

(71) Applicants: Victor Aleksandrovich Sledkov, Guangzhou (CN); Zi-Meng Li, Dongguan (CN)

(72) Inventors: Victor Aleksandrovich Sledkov, Guangzhou (CN); Zi-Meng Li, Dongguan (CN)

(21) Appl. No.: 15/507,763

(22) PCT Filed: Sep. 11, 2015
(86) PCT No.: PCT/CN2015/094083

§ 371 Date: Mar. 1, 2017

(30) Foreign Application Priority Data
Nov. 11, 2014 (CN) 201410630651.9

(51) Int. Cl. H01Q 3/26; H01Q 21/00

(52) U.S. Cl. CPC H01Q 3/26; H01Q 21/0075; H01Q 23/00

(57) ABSTRACT

This paper discloses an adjustable phase shifting device for antenna array as well as an antenna array, the device including a branched network of feed lines containing transformer portions of varying width for reducing reflection of signals passing through the network and coupling the common input port with the output ports placed along the first edge of the device via one or more junctions and including portions of feed lines placed along the second edge of the device, the dielectric members mounted on one rod adjacent to these portions of feed lines and can be moved along ones to synchronously adjust the phase relationship between the output ports, the dielectric members having one or more transformer portions for reducing reflection of signals passing through the network, wherein the dielectric member mounted adjacent to portions of feed lines placed along the second edge of the device and connected with the first junction from input port contains transformer portions at both ends and other dielectric members contain transformer portions only at one end which overlap a portion of feed line placed along the second edge of the device.

### FIELD OF INVENTION

The invention relates to a dielectric phase shifting device, more particularly an adjustable phase shifting device for antenna array as well as an antenna, for feeding signals between a common line and two or more ports, for example for feeding radiators of antenna array from an antenna input.

### BACKGROUND OF THE INVENTION

The electrically adjustable antenna for base station facilitates tilt adjustment of beam of base station antenna via phase shifter in beam-forming networks, characterized in wide-range tilt adjustment, high precision, easily-managed direction pattern, strong capacity of resisting disturbance, and easy control. Phase shifter acting as an essential component of base station antenna can adjust tilt angle of antenna beam by changing the relative phase between antenna units, thus improve communication network. In principle, a beam-forming network for electrically adjustable antenna can be formed in two methods. One is to insert dielectric into feed line to alter the dielectric constant during transmission, thus to change wavelength of electromagnetic wave to suit the change of the travelling electromagnetic wave, meaning the change of the feed phase. The other is to alter length of feed lines either by increasing or decreasing, which means to increase or decrease the route of electromagnetic wave directly so as to change the feed phase, wherein change of feed line is small and loss is low, yet some implementations would cause non-linear changes of the phase, complicated achievement or bad intermodulation.

A beam-forming network is previously known in U.S. Pat. No. 5,949,303, wherein phase shift is achieved by a dielectric member moving between a substrate and meander-shaped feed network, and the phase difference between different output ports achieved by transmission line dielectric of the feed network covering different lengths. The disadvantage: the meander-shaped loops are parallel so the device is relatively large in the lateral. Further, the relative position of output break will affect distribution, which is against reducing signal reflection and designing components with broadband response, and adding to the complexity of phase shifter structure, even in contradiction with reality in some applications.

A beam-forming network is previously known in CN1547788A, wherein the phase shift among a plurality of ports is achieved by relative sliding between a highly-integrated circuit board and thin dielectric plate, similar to that described in U.S. Pat. No. 5,949,303. However, it is difficult to guarantee that the too-thin dielectric plate will remain the same due to the material and mechanical strength, and the phase shifter may get completely jammed or the phase shift precision may be affected due to uneven force the deformed dielectric plate got during the movement as a result.

As stated previously, current technology apparently encounters defect and inconvenience in actual use. Yet the fast-pacing mobile communication technology advances the trend of miniaturization, broadband and multi-frequency related to base station antenna, demanding new phase shifter structures of low-cost but high performance to deal with the said issues.

### SUMMARY OF THE INVENTION

This application is intended to provide a novel structure for improving beam-forming network and related application with a view to deficiency of current beam-forming network. A technical proposal is presented as follows:

This application discloses an adjustable phase shifting device for antenna array for feeding signals between a common input port and two or more output ports, the device including a branched network of feed lines containing transformer portions of varying width for reducing reflection of signals passing through the network and coupling the common input port with the output ports placed along the first edge of the device via one or more junctions and including portions of feed lines placed along the second edge of the device, the dielectric members mounted on a rod adjacent to these portions of feed lines and can be moved along ones to synchronously adjust the phase relationship between the output ports, the dielectric members having one or more transformer portions for reducing reflection of signals passing through the network, wherein the dielectric member mounted adjacent to portions of feed lines placed along the second edge of the device and connected with the first junction from input port contains transformer portions at both ends and other dielectric members contain transformer portions only at one end which overlap a portion of feed line. The branched network of feed lines consist of strip lines placed inside of the conductive box having two wide walls placed above and below strip lines and two narrow walls. The strip lines connected with the output ports contain dielectric substrates placed between wide walls on both sides of strip lines, and also contain nonconductive spacers supporting the strip lines between wide walls. Each dielectric member contains two equal parts placed between wide walls on both sides of each portion of strip line placed along the second edge of the device and fixed on a rod. Each dielectric member made as one part contains a longitudinal slot for strip lines and a longitudinal hole or channel for the rod, the inside surface of the slot is positioned with chamfers for strip lines and lugs for mounting the dielectric members on the rod by installation these lugs into holes made in a rod.

It should be noted that conventional adjustable phase shifting device for antenna array is placed in an independent cavity which is on rear face of reflecting plate and supported by pillars, and conventional antenna array is connected with cables. The key point about the adjustable phase shifting device or antenna array as claimed in this application is replacing cables with strip lines, thus reducing thickness of the device and base station antenna as well as dimension of antenna. In one embodiment of this application the reflecting plate and phase shift cavity are made as one part sharing the same surface, while in current designs, they are separate components wherein phase shifter is supported on reflecting plate and drive mechanism for phase shifter is higher than phase shifter, resulting in increasing height of antenna. The phase shifting device and strip lines are directly placed in the reflector chamber in this application, the drive mechanism implanted in the phase shifter, thus greatly reducing overall thickness of the antenna. The adjustable phase shifting device for antenna array as claimed in this application using strip lines: firstly, compared with cables, strip lines boast low loss acquiring better benefit. Secondly, strip lines free of cables greatly decrease soldering points to reduce chance of intermodulation during production and raise first pass yield during antenna production, and consistency of standing waves is good as well. Thirdly, real automation can be facilitated due to the modularity of components, achieving easy manufacturing and installing. Fourthly, strip lines can be manufactured by metal stamping in case of mass production, boasting low cost and high efficiency. Fifthly, the adjustable phase shifting device for antenna array as claimed in this application wherein antennas of varying perpendicular direction patterns can be designed in accordance with requirement just by altering strip line structure. Sixthly, the adjustable phase shifting device for antenna array in this application wherein if an antenna array has N radiators, the device can be placed with N-1 phase shifters all of which can be finely accommodated inside the reflector chamber without any increase in dimension, while existing antenna can accommodate only 1-5 phase shifters.

Preferably, transformer portions of the dielectric members formed by cuts reducing width of the dielectric members.

Preferably, transformer portions of the dielectric members formed by cuts reducing thickness of the dielectric members.

Preferably, the rod made of material having small thermal extension, for example metal or fiberglass.

Preferably, the feed lines consist of strip lines placed inside of the conductive cavity having two wide walls placed above and below strip lines and two narrow walls.

Preferably, the conductive cavity made as a metal profile by extrusion.

Preferably, a conductive cavity contains the longitudinal projections on the inner surfaces of wide walls nearby the second edge of the device.

Preferably, each dielectric member contains two equal parts placed between wide walls on both sides of each portion of strip line placed along the second edge of the device and fixed on a rod.

Preferably, each dielectric member made as one part containing the longitudinal slot for a strip line and the longitudinal hole or channel for the rod.

Preferably, each dielectric member contains the longitudinal slots for the longitudinal projections placed on inner surfaces of wide walls.

Preferably, each dielectric member is made of upper and lower layers and a plastic profile made by extrusion.

Preferably, each dielectric member made as one part containing the longitudinal slot for a strip line and the lugs for mounting the dielectric member on a rod by installation these lugs into holes made in a rod.

Preferably, the dielectric member made by injection in a mold has at least one gap for adjusting the contact between the dielectric member and the feed network.

Preferably, at least some portions of the strip lines connected with output ports contain dielectric substrates placed between wide walls on both sides of strip lines.

Preferably, dielectric substrates made of material having low dielectric constant, preferably polyethylene foam.

Preferably, at least some portions of the strip lines connected with output ports contain nonconductive spacers supporting the strip lines between wide walls.

Preferably, the strip lines formed on one side of the lower dielectric substrate supporting the strip lines between wide walls.

Preferably, the upper dielectric substrate is placed on the strip lines formed on the lower dielectric substrate.

Preferably, the strip lines formed on both sides of the thin dielectric substrate supporting the strip lines between wide walls.

Preferably, at least one feed line placed between a junction and an output port contains the portion having wave impedance at least 20% more than impedance of the output port and the transformer portion connected to an output port.

This paper also discloses an antenna including the device as claimed wherein at least two antenna elements connected to outputs of the device directly or via coaxial cables.

The beneficial effect of this application: the adjustable phase shifting device for antenna array is designed based on phase shift method of inserting dielectric, characterized in highly integrated feed network, adoption of strip lines for connecting, free of nonlinear electric connection point and fine intermodulation. The dielectric member placed in the guide slot boasts small transmission error, high-precision declination and smooth transmission. In addition, phase shift calibration is of linear change during movement of the dielectric member.

The highly-integrated feed network free of cables makes insertion loss of the entire circuit very small, approximately 0.3 dB in the case of 3 GHz. Base station antenna using this design would have higher gains.

The adoption of metallic strip lines for the highly-integrated feed network free of cables can be made by stamping process which costs less than cables.

The highly-integrated feed network free of cables can be designed as a modular component allowing for realization of automation, reducing labor force by 80% and cutting cost as a result. Yet automatic production by robots is impossible in design of cables.

### DESCRIPTION OF THE DRAWINGS

FIG. 1 is a drawing of internal structure of beam-forming network of one embodiment.

FIG. 2 is a drawing of general appearance of beam-forming network of one embodiment.

FIG. 3 is a drawing of overall cross section of beam-forming network of one embodiment.

FIG. 4 is a drawing of partial enlargement of dielectric member of one embodiment.

FIG. 5 is a drawing of internal structure of beam-forming network of another embodiment

FIG. 6 is a drawing of general appearance of beam-forming network of another embodiment.

FIG. 7 is a drawing of overall cross section of beam-forming network of another embodiment.

FIG. 8 is a drawing of general appearance of aggregate beam forming network device of one embodiment.

FIG. 9 is a drawing of cross section of double-deck metallic cavity of aggregate beam forming network device of one embodiment.

FIG. 10 is a drawing of overall cross section of aggregate beam forming network device of one embodiment.

FIG. 11 is a drawing of internal structure of aggregate beam forming network device of one embodiment

### DETAILED DESCRIPTION OF THE INVENTION

The adjustable phase shifting device for antenna array comprises input port, at least two output ports, a feed network for connecting input port with output ports, dielectric substrates for supporting feed network, a rod, dielectric members fixedly mounted on the rod and metallic rectangular cavity. The highly integrated feed network for connecting antenna elements has integrated strip lines instead of cables and is secured between two dielectric substrates. Two ends of conductive cavity are open while other end faces are closed to form a rectangular cavity on one side of which the feed network mounted with dielectric members is placed. The dielectric members mounted on the rod according to the design and having guide slot clip the strip lines between the upper and lower layer. The other side of the metallic cavity is placed with guide slot and guide projection, the guide projection stuck in the guide slot for dielectric members while the rod placed in the guide slot of the metallic cavity such that the dielectric members can move on the planar surface of the feed network by pulling the rod. This new-type beam forming network illustrates that if an antenna array has N radiators, the beam forming network would have N-1 phase shifters, to achieve a good direction pattern both horizontally and vertically. Further, in this design, the feed network for connecting antenna array units has integrated strip lines instead of cables.

The feed network, which is highly integrated for connecting antenna array units and uses integrated strip lines instead of cables, are secured between two symmetrical dielectric substrates upon which is placed with fixed holes for corresponding feed network. The dielectric substrates must be a little longer than the feed network while the feed network must be wider than the dielectric substrates, the input and output ports of the feed network having no dielectric substrates to overlap them.

In this application, if an antenna array has N radiators, the beam forming network would have N-1 phase shifters.

The cavity for feed network installation is a rectangular conductive cavity with two open ends, side wall of the narrower side of the cavity placed with mounting hole for input and output ports, while surface of the wider side placed with mounting hole for dielectric substrate.

Inside the conductive cavity, one side has guide slot and guide projection, and the side with mounting hole has the feed network placed with dielectric substrate. Dielectric members are secured on the rod with up-down symmetry and with a narrow deep slot down to the bottom which is not running through.

The strip lines are in the middle of the narrow deep slot related to the dielectric members one side of which has a guide slot. On the dielectric members there are one or more gaps whose shape and quantity are determined by design, and on one side at the bottom there are hot-riveting pillars for fixing the fiberglass rod. The dielectric members, either made by two dielectric sheets or made as an entirety, has a chamfer for strip lines, and the slide rod mounted with dielectric members is positioned on one side of the conductive cavity where guide slot and guide projection are placed, a small separated cavity having input and output ports inside is positioned on the other side. The conductive cavity placed with feed network is configured by single- or multi-layer cavity.

A more detailed description of this application may be acquired by referring to the following embodiments in cooperation with the accompanying drawings. The embodiments are for the understanding and description of this application, but should not be interpreted as a limitation on this application.

### Embodiment One

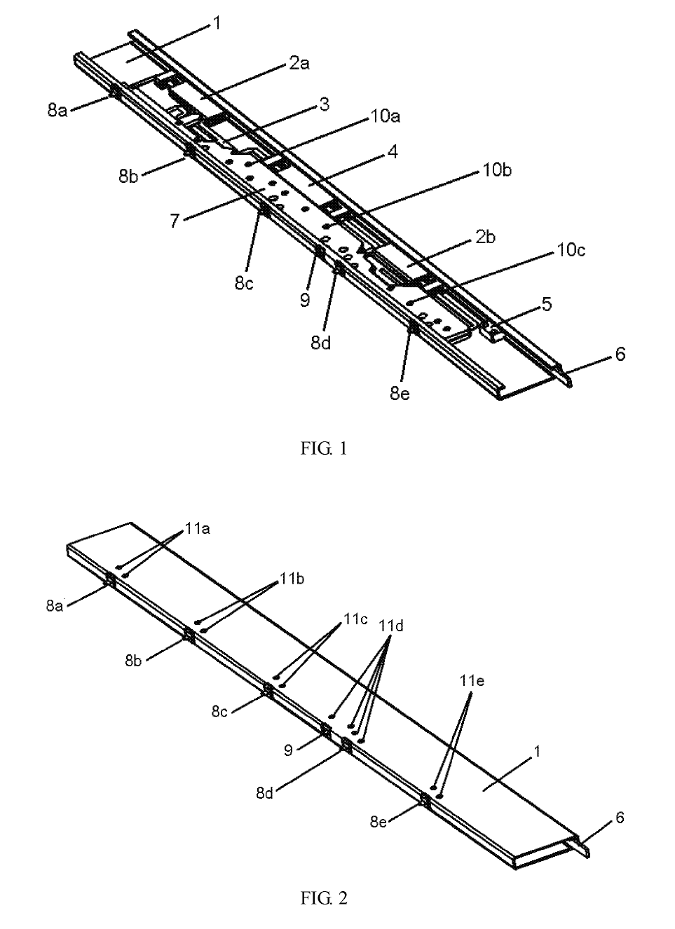

The beam-forming network for the electrically adjustable antenna as claimed in this application referring to FIGS. 1-3. FIG. 1 illustrates embodiment one of this application including output ports 8a, 8b, 8c, 8d and 8e, input port 9, a drive mechanism comprising dielectric members 2a, 2b and 4, a fiberglass rod 6, a slide block 5, the fiberglass rod 6 having fixed holes through which the dielectric members 2a, 2b and 4 having plastic pillars on one side respectively are secured on the fiberglass rod 6 by means of riveting process. Because of the strong pulling force the slide block 5 has to endure, POM is selected for production. The slide block 5 also has columns secured on the fiberglass 6 by riveting process. Strip lines 3 are clipped between the two same-type dielectric substrates 7 which have fixing holes 10a, 10b and 10c through which the strip lines 3 are firmly clipped between the two substrates 7 by plastic fasteners or plastic-heat riveting. One side of the metallic cavity 1 has gaps in which the output ports 8a, 8b, 8c, 8d, 8e and the input port 9 of the feed network are placed. As in FIG. 2, the strip lines 3 placed with dielectric substrates 7 are secured inside the metallic cavity 1 via plastic rivets 11a, 11b, 11c, 11d and 11e, the output ports 8a, 8b, 8c, 8d, 8e and the input port 9 are secured outside. The fiberglass rod 6 can be used as ruler.

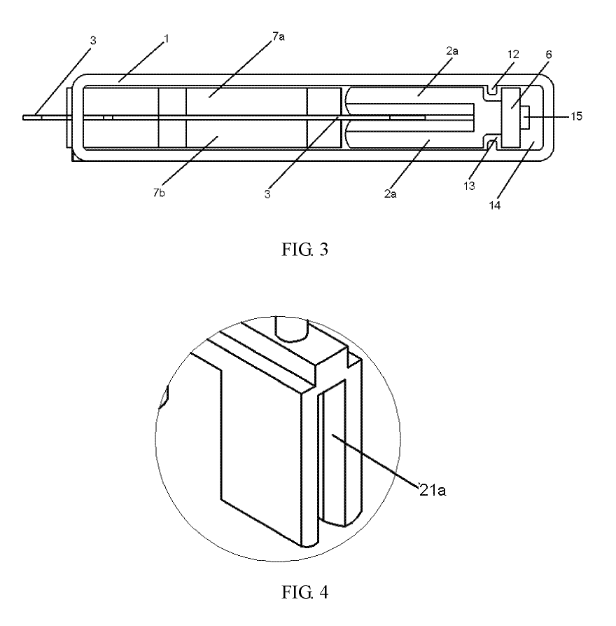

FIG. 3 shows a sectional view of the entire conductive cavity. The fiberglass rod 6 is placed inside the guide slot 14 of the conductive cavity 1. On the dielectric members 2a, 2b and 4 is the guide slot 13 placed on the guide projection 12 of the conductive cavity 1. FIG. 4 illustrates the dielectric members having a chamfer 21a used for guiding the strip lines during phase shift adjustment. Strip lines 3 are placed inside the slot in the dielectric members 2a, 2b and 4 which would move along in the guide slot and guide projection of the metallic cavity when pulling the slide carriage. This configuration can avoid mechanical strength issue caused by long dielectric members, with the outcome of high-precision phase shift as well as low cost.

### Embodiment Two

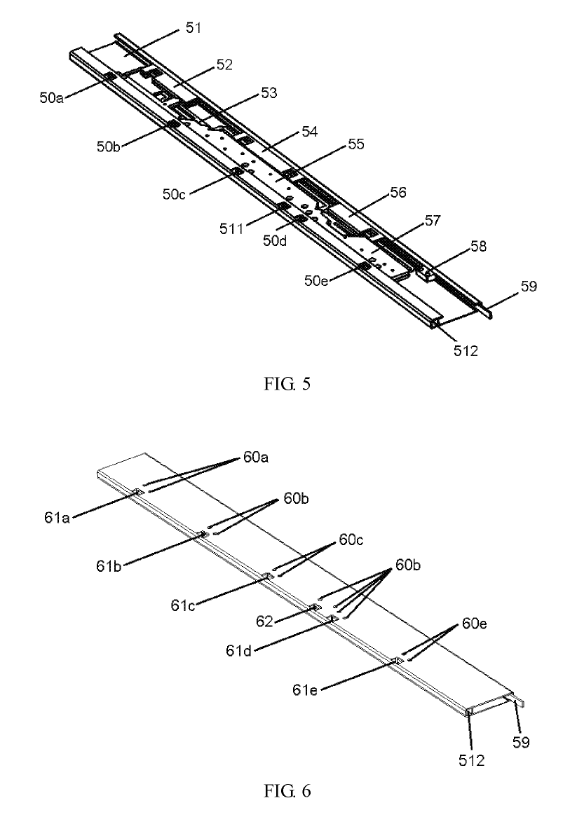

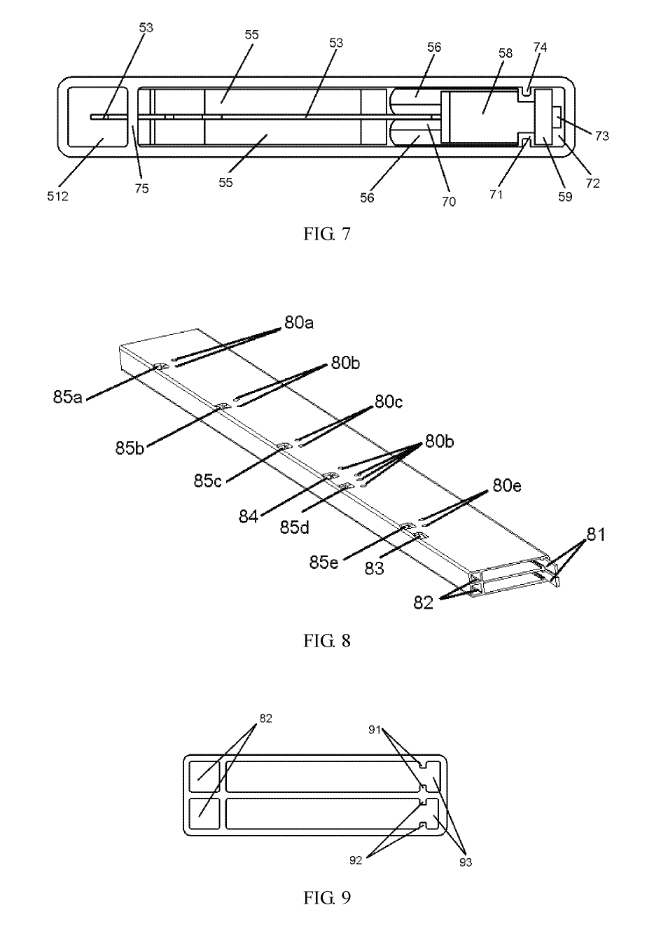

The beam-forming network for electrically adjustable antenna of this embodiment as shown in FIGS. 5-7 is alike embodiment one illustrated above. Just one end of where the input ports 50a, 50b, 50c, 50d, 50e and the output port 511 are positioned has a small cavity 512, as in FIG. 5. On the metallic cavity 51 are holes 50a, 50b, 50c, 50d, 50e, 511, strip lines 53, dielectric substrates 55, and mounting hole 57, the strip lines 53 firmly clipped between the two same dielectric substrates 55 via plastic fasteners or plastic-heat riveting and on the same half of the metallic cavity with the input ports 50a, 50b, 50c, 50d, 50e and the output port 511. The dielectric members 52, 54 and 56 as well as the slide carriage 58 made of POM are fixed on the fiberglass rod 59 via plastic-heat riveting. FIG. 7 shows riveting point 73, fiberglass rod 59 placed in guide slot 72, slide carriage 58 and dielectric member 56 sharing guide slot 71 and placed in guide projection 74. The dielectric members have slots and chamfer 70 in cross section respectively for adjusting and leading the strip lines when pulling the rod 59. FIG. 6 illustrates metallic cavity having holes 60a, 60b, 60c, 60d and 60e through which the dielectric substrates 55 and the strip lines 53 are secured in the cavity via plastic rivets. 61a, 61b, 61c, 61d, 61e are holes on the cavity surface for output ports while 62 for input port. 512 is a small cavity for closing input and output ports, which can effectively suppress coupling in dual-polarized antennas.

### Embodiment Three

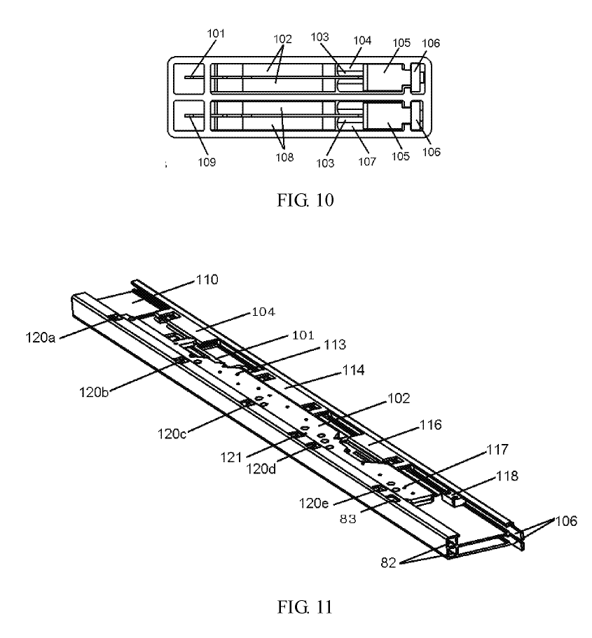

Referring to FIGS. 8-11, the beam-forming network device for electrically adjustable antenna of this embodiment wherein the device is actually an overlapping of two the beam forming network described in embodiment one. FIG. 11 shows internal structure of the first layer including metallic cavity 110, feed network which is placed inside the cavity, strip lines 101 mounted between two dielectric substrates 102 and secured by fasteners through holes 113 and 117 on the side where the input port 121, output ports 120a, 120b, 120c, 120d, 120e and the support end 83 are placed. The slide rod 106 is positioned with dielectric members 104, 114, 116 and slide carriage 118. The metallic cavity 110 has on one side a small cavity 82 in which the input and output ports are placed. FIG. 8 shows a double-layer cavity, and fixing holes 80a, 80b, 80c, 80d, 80e which have plastic rivets 102 inside and which are on the surface of the cavity for output ports, 84 is a hole for input port, 83 a support port, 82 two overlapping but independently separated small cavities in which input and output ports are placed. Refer to FIG. 10 for more detailed illustration wherein strip lines 101 and 109 are clipped between dielectric substrates 102 and 108 in the overlapping cavities, and are placed in right the middle of the slots on the dielectric members. Dielectric members 104 and 107 have chamfers 103 for guiding the strip lines. Fiberglass rod 106 is placed in the guide slot of the cavity while slide carriage 105 is in guide projection such that the whole unit can move smoothly in the cavity when pulling the fiberglass rod 106. This embodiment is suitable for long antenna or multi-frequency antennas.

While the foregoing have been merely preferred embodiments related to this application, it should not be interpreted as a limitation on the scope of this application. Those skilled in the art will recognize that various changes, modifications and equivalents may be made without departing from the spirit and scope of the invention.

1. An adjustable phase shifting device for feeding signals between a common input port and two or more output ports, the device including a branched network of feed lines containing transformer portions of varying width for reducing reflection of signals passing through the network and coupling the common input port with the output ports placed along the first edge of the device via one or more junctions and including portions of feed lines placed along the second edge of the device, the dielectric members mounted on one rod adjacent to these portions of feed lines and can be moved along ones to synchronously adjust the phase relationship between the output ports, the dielectric members having one or more transformer portions for reducing reflection of signals passing through the network, wherein the dielectric member mounted adjacent to portions of feed lines placed along the second edge of the device and connected with the first junction from input port contains transformer portions at both ends and other dielectric members contain transformer portions only at one end which overlap a portion of feed line placed along the second edge of the device.

2. The device of claim 1 wherein transformer portions of the dielectric members formed by cuts reducing width of the dielectric members.

3. The device of claim 1 wherein transformer portions of the dielectric members formed by cuts reducing thickness of the dielectric members.

4. The device of claim 1 wherein the rod made of material having small thermal extension, for example metal or fiberglass.

5. The device of claim 1 wherein the feed lines consist of strip lines placed inside of the conductive box having two wide walls placed above and below strip lines and two narrow walls.

6. The device of claim 5 wherein the conductive cavity made as a metal profile by extrusion.

7. The device of claims 5 t 6 wherein a conductive box contains the longitudinal projections on the inner surfaces of wide walls nearby the second edge of the device.

8. The device of claims 1 wherein each dielectric member contains two equal parts placed between wide walls on both sides of each portion of strip line placed along the second edge of the device and fixed on a rod.

9. The device of claim 1 wherein each dielectric member made as one part containing the longitudinal slot for a strip line and the longitudinal hole or channel for a rod.

10. The device of claim 8 wherein each dielectric member contains the longitudinal slots for the longitudinal projections placed on inner surfaces of wide walls.

11. The device of claim 8 wherein each dielectric member is made of upper and lower layers and a plastic profile made by extrusion.

12. The device of claim 1 wherein each dielectric member made as one part containing the longitudinal slot for a strip line and the lugs for mounting the dielectric member on a rod by installation these lugs into holes made in a rod.

13. The device of claim 12 wherein the dielectric members made by injection in a mold has at least one gap for adjusting the contact between the dielectric members and the feed network.

14. The device of claim 1 wherein at least some portions of the strip lines connected with output ports contain dielectric substrates placed between wide walls on both sides of strip lines.

15. The device of claim 14 wherein dielectric substrates made of material having low dielectric constant, preferably foam-type material, for example polyethylene foam.

16. The device of claim 1 wherein at least some portions of the strip lines connected with output ports contain nonconductive spacers supporting the strip lines between widewalls.

17. The device of claim 1 wherein the strip lines formed on one side of the lower dielectric substrate supporting the strip lines between wide walls.

18. The device according to claim 1 wherein the upper dielectric substrate is placed on the strip lines formed on the lower dielectric substrate.

19. The device of claim 1 wherein the strip lines formed on both sides of the dielectric substrate supporting the strip lines between wide walls.

20. The device of claim 1 wherein at least one feed line placed between a junction and an output port contains the portion having wave impedance at least 20% more than impedance of the output port and the transformer portion connected to an output port.

21. (canceled)
